(19) United States
(12) Patent Application Publication
(10) Pub. No.: US 2003/0168881 A1
(43) Pub. Date: Sep. 11, 2003

(54) Lock control assembly for a motor vehicle opening panel and opening panel equipped with same

(76) Inventors: Guillame Lesueur, Nevers (FR); David Simoneau, Lurcy-Levis (FR)

Correspondence Address: Longacre & White, Suite 240, 6550 Rock Spring Drive, Bethesda, MD, 20817, US

(21) Appl. No.: 10/311,283

(22) PCT Filed: Jun. 22, 2001
(86) PCT No.: PCT/FR01/01995

(30) Foreign Application Priority Data
Jun. 29, 2000 (FR) 00/08427

(51) Int. Cl. B60J 7/00

(52) U.S. Cl. 296/138

(57) ABSTRACT

This lock operating assembly comprises a main support (18) intended to press against a wall (16) of the opening panel (12) delimiting an external surface (16E) of this opening panel, and electric lock-operating means (20) intended to be connected to an electric operating circuit borne by the opening panel by electrical connection means (22). The electric operating means (20) and the electric connection means (22) are borne by the main support (18). As a preference, the electric operating means comprise a switch (20) actuated by an operating lever (26) borne by the main support (18), and the electrical connection means comprise an electric operating connector (22) intended to extend through an orifice (24) made in the opening panel (12).

Application to the operation of a motor vehicle trunk or tail hatch lock.

The present invention relates to a lock operating assembly for a motor vehicle opening panel and to an opening panel equipped with this assembly.

It applies in particular to the operation of a motor vehicle trunk or tail hatch lock.

Already known from the prior art is a lock operating assembly for a motor vehicle opening panel, of the type comprising a main support intended to press against a wall of the opening panel delimiting an external surface of this opening panel and electric lock operating means intended to be connected to an electric operating circuit borne by the opening panel by electrical connection means.

The electric operating circuit is generally designed to drive at least one electric actuator which operates the lock via, possibly, a central electronic unit.

If need be, the operating assembly may, in addition to the electric operating means, bear mechanical means for operating the lock.

Habitually, the lock operating assembly comprises a secondary support bearing the electric operating means and the electrical connection means. This secondary support is intended to rest against the internal surface of the wall of the opening panel. As a result, when the opening panel is in its normal closed position, the main support is visible and accessible from outside the vehicle while the secondary support is not. The main support contributes to the appearance of the vehicle.

In order to mount a lock operating assembly on the opening panel it is first of all appropriate to mount the main support resting on the external surface of the wall of the opening panel then to mount the secondary support on the internal surface of the wall of the opening panel so as to trap the wall of the opening panel between the main and secondary supports.

Added to these mounting operations are possibly some operations of mounting illuminating means on the main support and of connecting the means of operating the lock electrically and the lighting means to corresponding electric supply and/or operating circuits. The lighting means are intended, for example, to illuminate a registration plate fixed to the opening panel.

The purpose of the invention is to simplify the mounting and the structure of a lock operating assembly of the aforementioned type.

To this end, the subject of the invention is a lock operating assembly for a motor vehicle opening panel of the aforementioned type characterized in that the electric operating means and the electrical connection means are borne by the main support.

According to other features of this assembly:

the electric operating means comprise a switch actuated by an operating lever borne by the main support;

the electrical connection means comprise an electric operating connector intended to extend through an orifice made in the opening panel;

the operating lever is articulated to a secondary support borne by the main support, this secondary support bearing a switch and the operating connector;

the main support bears means of illuminating a surrounding area, such as an area in which a vehicle registration plate is fitted;

the main support bears means for fixing the operating assembly to the opening panel;

the fixing means comprise pre-fixing clips and permanent-fixing screws intended to collaborate with complementary pre-fixing and permanent fixing means formed on the opening panel;

the main support bears means of pre-positioning the operating assembly with respect to the opening panel, which means are intended to collaborate with complementary pre-positioning means formed on the opening panel;

the main support has the overall shape of a housing comprising a face, at least partially open, intended to rest against the external surface of the opening panel.

Another subject of the invention is an opening panel for a motor vehicle, characterized in that it comprises a lock operating assembly as defined herein above.

According to other features of this opening panel:

the sealing means are inserted between the main support and the external surface of the opening panel;

the sealing means comprise at least one sealing member through which the electric operating connector passes;

the sealing means comprise at least one sealing member surrounding facing orifices formed in the main support and in the opening panel in order to provide access to a bulb of the illuminating means which bulb is housed in the main support.

The invention will be better understood for reading the description which will follow, which is given solely by way of example and made with reference to the drawings in which:

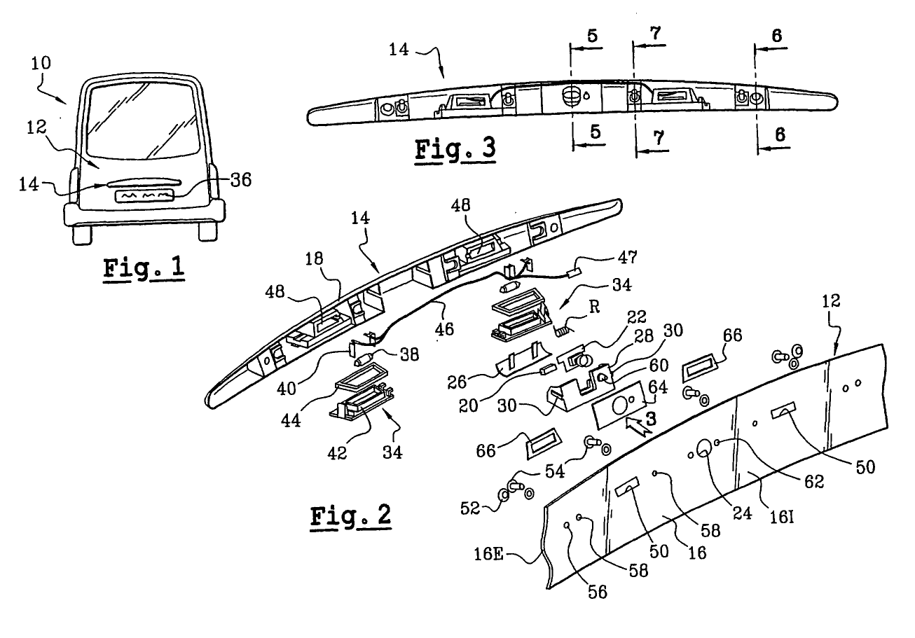

FIG. 1 is a view of a vehicle equipped with an opening panel according to the invention;

FIG. 2 is an exploded perspective view of a lock operating assembly according to the invention fitted to the opening panel of the vehicle depicted in FIG. 1;

FIG. 3 is a front-on view of the lock operating assembly depicted in FIG. 2, in the direction of arrow 3 of FIG. 2;

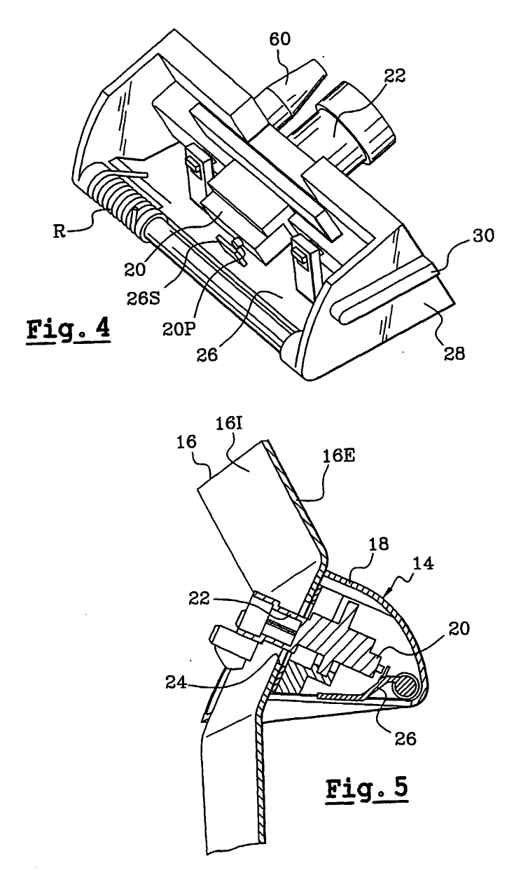

FIG. 4 is a detailed perspective view of the secondary support bearing the electric operating means and the electrical connection means;

FIG. 5 is a detailed perspective view with section on 5-5 of FIG. 3;

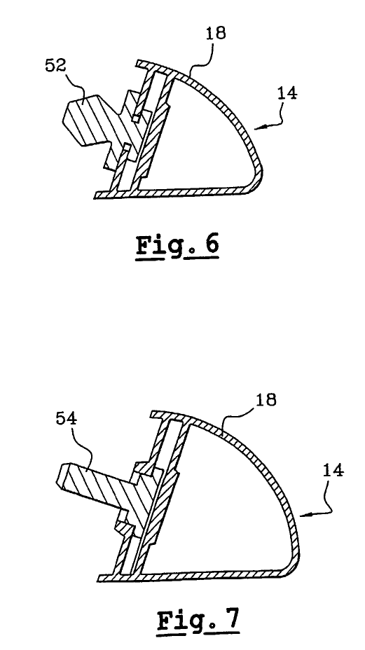

FIGS. 6 and 7 are views in section on 6-6 and 7-7 of FIG. 3 respectively.

FIG. 1 depicts a motor vehicle 10 equipped with an opening panel forming a tail hatch 12. This hatch 12 comprises a lock operating assembly according to the invention, denoted by the reference 14 and illustrated in greater detail in FIGS. 2 and 3. The lock, of conventional type, is not depicted in the figures.

The hatch 12 is delimited by a wall 16 a portion of which is depicted particularly in FIG. 2. The wall 16 is delimited by an internal surface 161 and an external surface 16E. The latter surface 16E is visible from the outside of the vehicle when the hatch 12 is in its normal closed position.

The assembly 14 comprises a main support 18 intended to press against the external surface 16E of the wall of the hatch.

The main support 18 has the overall shape of an elongate housing, elongate for example in the horizontal direction when considering FIG. 1.

The main support 18 comprises a face, at least partially open, intended to press against the external surface 1 6E of the wall of the hatch.

The assembly 14 comprises electric lock operating means intended to be connected to a conventional electric control circuit borne by the opening panel, by electrical connection means.

In the example illustrated, the electric operating means comprise a switch 20 of conventional type and the electrical connection means comprise an electric operating connector 22 of conventional type intended to extend through an orifice 24 made in the wall 16 of the opening panel (see FIGS. 2, 3 and 5).

The switch 20, connected electrically to the connector 22 by conventional means, is actuated by an operating lever 26, in the general form of a lever handle, articulated to a secondary support 28 borne by the main support 18.

The secondary support 28 bears the switch 20 and the operating connector 22, as depicted more clearly in FIGS. 4 and 5. In these figures, it will be noted that the switch 20 is provided with a push-button 20P intended to collaborate with a projection 26S on the lever for opening and closing the switch 20.

The switch 20 allows, for example, control of a lock-operating device of the “hands free” type. In the conventional way, this type of operating device comprises a central electronic unit intended to identify the user who wishes to unlock or lock the lock, by means of a magnetic recognition badge worn or carried by the user and detected by the central electronic unit. Thus, when the lever 26 is actuated, the switch 20 changes state to trigger the process of identification by the central electronic unit and, if appropriate, the unlocking or locking of the lock allowing the opening of the opening panel.

The secondary support 28 is fixed to the main support 14 by nesting means comprising, for example, rails 30, formed on the secondary support 28 and collaborating with corresponding grooves 32 made in the main support 18.

The operating lever 26 is returned elastically to a position of rest via a spring R with an angular effect depicted in particular in FIGS. 2 and 4.

The main support 18 bears a duplicated means 34 illuminating a surrounding area of the wall 16 of the hatch. This surrounding area is, for example, the area on the external surface 16E of the wall to which a registration plate 36 is fitted (see FIG. 1).

As a preference, the lighting means 34 comprise a bulb 38 in electrical contact with two metal terminals 40. The bulb 38 and the terminals 40 are housed in the main support 18. The light from the bulb 38 is diffused through a dioptric wall 42 borne by the main support 18. As a preference, a seal 44 is inserted between the main support 18 and the dioptric wall 42. The terminals 40 are connected to electrical supply means by conventional means comprising cables 46 and an electrical supply connector 47.

As an alternative, the operating connector 22 and electrical supply connector 47 could be combined into a single connector.

Orifices 48, 50 are formed facing each other in the main support 18 and in the wall 16 of the hatch so as to allow access to the bulb 38, particularly to replace it.

The main support 18 bears means for fixing the operating assembly 14 onto the wall 16 of the hatch. These fixing means comprise, for example, pre-fixing clips 52 (see FIG. 6) and permanent fixing screws 54 (see FIG. 7) intended to collaborate with complementary pre-fixing orifices 56 and complementary permanent fixing orifices 58 formed in the wall 16.

The main support 18 bears means of pre-positioning the operating assembly 14 with respect to the hatch 12. These pre-positioning means comprise, for example, a stud 60 fixed on the secondary support 28 and intended to collaborate with a complementary pre-positioning orifice 62 made in the wall 16 of the hatch.

Sealing means are inserted between the main support 18 and the external surface 16E of the wall of the hatch.

As a preference, these sealing means comprise at least one sealing member 64 through which the operating connector 22 and the pre-positioning stud 60 pass. This sealing member 64 is inserted between the secondary support 28 and the wall 16 so as to seal the operating connector 22.

Also as a preference, the sealing means additionally comprise at least one sealing member 66 inserted between the main support 18 and the wall 16 so as to surround the orifices 48, 50 allowing access to the bulb 38.

The sealing members 64, 66 are cut, for example, from self-adhesive sealing sheets.

The assembly 14 is very simple to mount on the hatch 12. First of all, the assembly 14 is mated with the wall 16, using the pre-positioning stud 60, then the assembly 14 is prefixed to the wall 16 using the clips 52. Next, the assembly 14 is permanently fixed to the hatch by means of nuts screwed onto the screws 54. Finally, the operating connector 22 and the electrical supply connector 47 are connected to the corresponding electric circuits.

Among the advantages of the invention, a note will be made of the fact that is allows means with various functions, such as electric operating means, electrical connection means and lighting means, to be combined in the assembly 14.

Thus, the lock operating assembly 14 forms a module the various elements of which can be preassembled prior to the mounting of this assembly 14 on the hatch 12.

1. A lock operating assembly for a motor vehicle opening panel (12), of the type comprising a main support (18) intended to press against a wall (16) of the opening panel delimiting an external surface (16E) of this opening panel, and electric lock-operating means (20) intended to be connected to an electric operating circuit borne by the opening panel (12) by electrical connection means (22), characterized in that the electric operating means (20) and the electric connection means (22) are borne by the main support (18).

2. The assembly as claimed in claim 1, characterized in that the electric operating means comprise a switch (20) actuated by an operating lever (26) borne by the main support (18).

3. The assembly as claimed in claim 2, characterized in that the electrical connection means comprise an electric operating connector (22) intended to extend through an orifice (24) made in the opening panel (12).

4. The assembly as claimed in claims 2 and 3 taken together, characterized in that the operating lever (26) is articulated to a secondary support (28) borne by the main support (18), this secondary support (28) bearing a switch (20) and the operating connector (22).

5. The assembly as claimed in any one of the preceding claims, characterized in that the main support (18) bears means (34) of illuminating a surrounding area, such as an area in which a vehicle registration plate (36) is fitted.

6. The operating assembly as claimed in any one of the preceding claims, characterized in that the main support (18) bears means (52, 54) for fixing the operating assembly to the opening panel (12).

7. The assembly as claimed in claim 6, characterized in that the fixing means comprise pre-fixing clips (52) and permanent-fixing screws (54) intended to collaborate with complementary pre-fixing (56) and permanent fixing (58) means formed on the opening panel (12).

8. The assembly as claimed in any one of the preceding claims, characterized in that the main support (18) bears means (60) of pre-positioning the operating assembly with respect to the opening panel (12), which means are intended to collaborate with complementary pre-positioning means (62) formed on the opening panel (12).

9. The assembly as claimed in any one of the preceding claims, characterized in that the main support (18) has the overall shape of a housing comprising a face, at least partially open, intended to rest against the external surface (16E) of the opening panel (12).

10. A motor vehicle opening panel, characterized in that it comprises a lock operating assembly as claimed in any one of the preceding claims.

11. The opening panel as claimed in claim 10, characterized in that the sealing means (64, 66) are inserted between the main support (18) and the external surface (16E) of the opening panel.

12. The opening panel as claimed in claim 11 taken in conjunction with claim 3, characterized in that the sealing means comprise at least one sealing member (64) through which the electric operating connector (22) passes.

13. The opening panel as claimed in claim 11 taken in conjunction with claim 5, characterized in that the sealing means comprise at least one sealing member (64) surrounding facing orifices (48, 50) formed in the main support (18) and in the opening panel (12) in order to provide access to a bulb (38) of the illuminating means which bulb is housed in the main support (18).
